(19) United States
(12) Patent Application Publication
(10) Pub. No.: US 2015/0222003 A1
(43) Pub. Date: Aug. 6, 2015

(54) MICROWAVE CIRCUIT

(71) Applicant: Panasonic Intellectual Property Management Co., Ltd., Osaka (JP)

(72) Inventors: Suguru Fujita, Tokyo (JP); Ryosuke Shiozaki, Tokyo (JP); Yuichi Kashino, Ishikawa (JP); Kentaro Watanabe, Hyogo (JP)

(21) Appl. No.: 14/424,811

(22) PCT Filed: Jun. 3, 2014
(86) PCT No.: PCT/JP2014/002934

§ 371 Date: Feb. 27, 2015

(30) Foreign Application Priority Data
Jun. 11, 2013 (JP) 2013-122795

(51) Int. Cl. H01P 3/08

(52) U.S. Cl. CPC H01P 3/08

(57) ABSTRACT

A microwave circuit that can suppress deterioration of transmission characteristics and that can be reduced in size is provided. The microwave circuit includes a first transmission line, a second transmission line, a third transmission line that is connected to the first transmission line and the second transmission line and whose line width is different from line width of the first transmission line and line width of the second transmission line, and a first ground conductor that surrounds the first transmission line, the second transmission line, and the third transmission line, respectively, at certain distances.

### TECHNICAL FIELD

The present disclosure relates to a microwave circuit. In addition, for example, the present disclosure relates to a microwave circuit board and a microwave circuit package including the microwave circuit.

### BACKGROUND ART

Currently, as a microwave circuit that conveys microwave signals, a high-frequency transmission line board that reduces a loss in transmission lines is known in which transmission line surrounded by a ground is provided on either side of a double-sided board and the grounds are connected to each other by vias (for example, refer to PTL 1).

### CITATION LIST

### Patent Literature

PTL 1: Japanese Unexamined Patent Application Publication No. 2001-298306

### SUMMARY OF INVENTION

### Technical Problem

In a high-frequency transmission line board disclosed in PTL 1, for example, in a structure illustrated in FIG. 5, a pass loss is reduced by adjusting a distance between an inner coplanar line 80 and an outer coplanar line 70 or a distance between a conductor via 71b and signal line layers 69 and 79. It is to be noted that the conductor via 71b connects an inner ground layer 78 to an outer ground layer 68.

In this structure, however, when circuits having different values of impedance are connected to ends of transmission lines, it is difficult to suppress deterioration of transmission characteristics and reduce the board in size.

The present disclosure has been established in view of the above circumstance, and an embodiment of the present disclosure provides a microwave circuit that, even though circuits having different values of impedance are connected to ends of transmission lines, can suppress deterioration of transmission characteristics and that can be reduced in size.

### Solution to Problem

A microwave circuit according to an embodiment of the present disclosure includes a first transmission line, a second transmission line, a third transmission line that is connected to the first transmission line and the second transmission line and whose line width is different from line width of the first transmission line and line width of the second transmission line, and a first ground conductor that surrounds the first transmission line, the second transmission line, and the third transmission line, respectively, at certain distances.

### Advantageous Effects of Invention

According to an embodiment of the present disclosure, deterioration of transmission characteristics can be suppressed and the size of a microwave circuit can be reduced even though circuits having different values of impedance are connected to ends of transmission lines.

### BRIEF DESCRIPTION OF DRAWINGS

FIG. 1(A) is a plan of an example of the structure of a microwave circuit according to a first embodiment, FIG. 1(B) is a cross-sectional view of the microwave circuit according to the first embodiment taken along line A-A′, and FIG. 1(C) is a cross-sectional view of the microwave circuit according to the first embodiment taken along line B-B′.

FIG. 2 is a plan of an example of the structure of a microwave circuit according to a second embodiment.

FIG. 3 is a plan of an example of the structure of a microwave circuit according to a third embodiment.

FIG. 4 is a plan of an example of the shape of a transmission line according to a modification.

FIG. 5 is a schematic diagram illustrating a high-frequency transmission line board described in PTL 1.

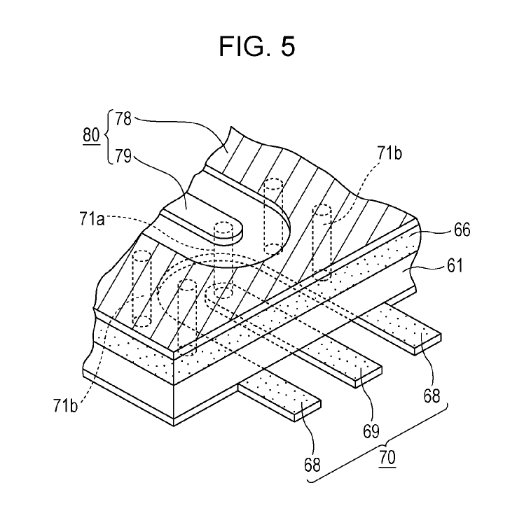

### DESCRIPTION OF EMBODIMENTS

Embodiments of the present disclosure will be described with reference to the drawings.

(Details of Establishment of Embodiment of Present Disclosure)

In a technique disclosed in PTL 1, a matching band in which impedance is matched is narrow. In order to realize desirable signal transmission when circuits having different values of impedance are connected to ends of transmission lines, at least two transmission lines having about a quarter length of wavelength are necessary. When, for example, a signal in a 60 GHz band is assumed in this case, each transmission line needs to have a length of about 1.25 mm, which makes it difficult to reduce a microwave circuit in size. In addition, when each transmission line is long, a loss in each transmission line becomes large.

Microwave circuits that can suppress deterioration of transmission characteristics and that can be reduced in size will be described hereinafter.

The microwave circuits according to the embodiments that will be described hereinafter are applied to wireless communication circuits, signal processing circuits, and passive circuits that conveys microwave (for example, millimeter waves at 60 GHz) signals. In addition, the microwave circuits are included in, for example, wireless modules.

### First Embodiment

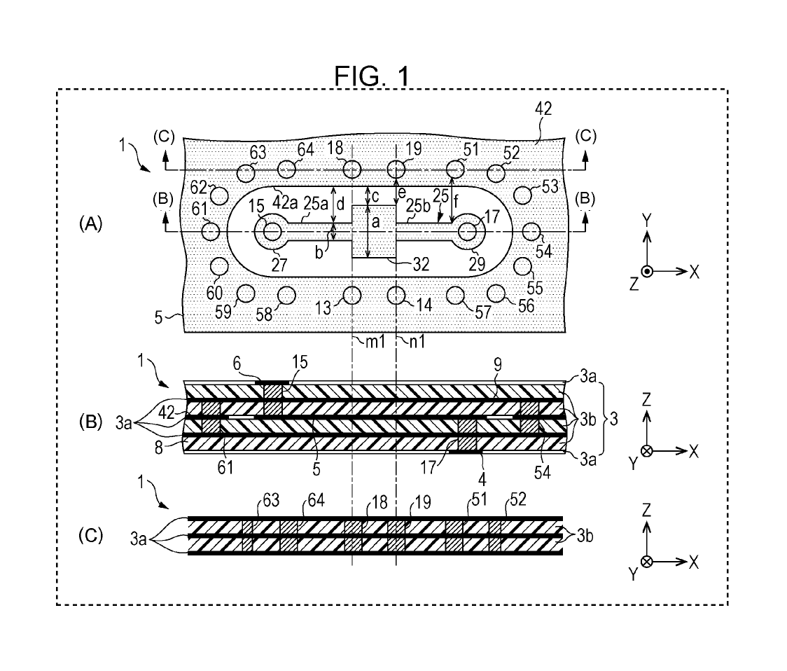

FIGS. 1(A) to 1(C) are diagrams illustrating an example of the structure of a microwave circuit 1 according to a first embodiment. The microwave circuit 1 according to this embodiment includes a multilayer board 3. Five metal layers 3a and four dielectric layers 3b, which, for example, are composed of a resin, sandwiched between the metal layers 3a are included. It is to be noted that the multilayer board 3 is not limited to the above configuration, and it is sufficient that the multilayer board 3 includes at least three metal layers and at least two dielectric layers sandwiched between these three metal layers.

Here, a plane parallel to surfaces of the multilayer board 3 is determined as an XY plane, a longitudinal direction of a transmission line 25 included in the microwave circuit 1 is determined as an X direction, and a width direction of the transmission line 25 is determined as a Y direction. In addition, a direction perpendicular to the surfaces of the multilayer board 3, that is, a direction perpendicular to the XY plane, is determined as a Z direction.

FIG. 1(A) is a plan of a second wiring layer 5 included in the multilayer board 3 viewed from above (positive Z axis direction). FIG. 1(B) is a cross-sectional view of an example of a cross-section of the multilayer board 3 taken along line A-A illustrated in FIG. 1(A). FIG. 1(C) is a cross-sectional view of an example of a cross-section of the multilayer board 3 taken along line B-B illustrated in FIG. 1(A).

The five metal layers 3a include a first wiring layer 4, the second wiring layer 5, and a third wiring layer 6 mainly used for wiring signal lines and a first GND layer 8 and a second GND layer 9 mainly used as grounds (GNDs). As illustrated in FIG. 1(B), the first wiring layer 4, the first GND layer 8, the second wiring layer 5, the second GND layer 9, and the third wiring layer 6 are arranged in this order from the bottom (negative Z axis direction) as the five metal layers 3a. The second wiring layer 5 is an example of a first layer, and the first GND layer 8 and the second GND layer 9 are examples of a second layer.

The third wiring layer 6 is electrically connected to the second wiring layer 5 by a signal via (also simply referred to as a via) 15. The second wiring layer 5 is electrically connected to the first wiring layer 4 by a signal via (also simply referred to as a via) 17.

The first wiring layer 4 and the third wiring layer 6 are outer surfaces of the multilayer board 3, and various electronic components are mounted on these layers.

On the second wiring layer 5, the transmission line 25, which extends in the X direction, is formed as an example of a wiring pattern. Pads 27 and 29 (electrode pads) are formed at an end and another end, respectively, of the transmission line 25. The transmission line 25 includes a first transmission line 25a, a second transmission line 25b, and a line width step portion 32 (third transmission line) extending in the X direction. The line width step portion 32 is formed in a central portion of the transmission line 25. The line width of the line width step portion 32 is larger than those of the other portions (the first transmission line 25a and the second transmission line 25b). Here, a width direction implied by the line width is the Y direction.

Thus, in FIG. 1(A), the transmission line 25 is formed such that the line width thereof changes from narrow to wide, and then to narrow in the X direction. In addition, the line width step portion 32 is arranged to be connected between the first transmission line 25a and the second transmission line 25b, thereby electrically connecting the first transmission line 25a and the second transmission line 25b to each other.

In addition, the pad 27 is connected to the third wiring layer 6 through the via 15. The pad 29 is connected to the first wiring layer 4 through the via 17.

The line width of the line width step portion 32 is constant and larger than those of the first transmission line 25a and the second transmission line 25b. The line width step portion 32 is formed to have, for example, a rectangular shape.

On the second wiring layer 5, for example, a GND pattern 42 including an elliptical (track-shaped) peripheral portion 42a (inner peripheral portion) that surrounds the transmission line 25 at certain distances is formed. The GND pattern 42 is an example of a first ground conductor.

As illustrated in FIG. 1(C), the GND pattern 42 is electrically connected to the first GND layer 8 and the second GND layer 9 by a plurality of ground vias formed in the second wiring layer 5. The plurality of ground vias (also simply referred to as vias) include vias 13, 14, 18, and 19 formed in a central portion of the second wiring layer 5 in the X direction. In addition, the plurality of ground vias include vias 51 to 57 and vias 58 to 64 formed to surround the pads 27 and 29 arranged in left and right parts of the second wiring layer 5.

The vias 13, 14, 18, and 19 are arranged near the peripheral portion 42a of the GND pattern 42 on or around lines m1 and n1 extending from both sides along the width direction (Y direction) of the line width step portion 32, which are indicated by dash-dot lines in FIG. 1(A). In a case where the four vias 13, 14, 18, and 19 are arranged near the peripheral portion 42a of the GND pattern 42, a gap between the via 13 and the via 14 and a gap between the via 18 and the via 19 are set to one eighth of the wavelength of microwaves (carrier waves) on the board. As a result, radiation of the microwaves to the outside from the line width step portion 32 is reduced, thereby suppressing a loss of power. It is to be noted that more than four grand vias may be arranged near the extended lines. Alternatively, ground vias may be arranged between the via 13 and the via 14 and between the via 18 and the via 19. These ground vias may be arranged on lines connecting the centers of the via 13 and the via 14 and the centers of the via 18 and the via 19 or on a side far from the peripheral portion 42a.

The seven vias 51 to 57 are arranged near the peripheral portion 42a of the GND pattern 42 in such a way as to surround the pad 29. Similarly, the seven vias 58 to 64 are arranged near the peripheral portion 42a of the GND pattern 42 in such a way as to surround the pad 27.

Unlike the four vias 13 to 19 described above, in a case where the vias 51 to 64 are arranged near the peripheral portion 42a of the GND pattern 42, these vias are arranged, for example, at smallest possible intervals in light of fabrication of the board. For example, these vias are arranged at intervals corresponding to distances twice as long as the diameters of the vias.

The vias 13, 14, 18, 19, and 51 to 64 are desirably arranged as close to the peripheral portion 42a as possible. In this case, the radiation of the microwaves to the outside from the line width step portion 32 can be further reduced, thereby suppressing the loss of power.

In addition, vias connected to the first GND layer 8 and the second GND layer 9 may or may not be provided between the via 51 and the via 19, between the via 64 and the via 18, between the via 57 and the via 14, and between the via 58 and the via 13.

Next, resonant frequencies of the microwave circuit 1 will be described.

As illustrated in FIG. 1(A), the line width of the line width step portion 32 is determined as a width a. The width of the other portions (the first transmission line 25a and the second transmission line 25b) is determined as a width b. In the microwave circuit 1, the width a and the width b are different from each other. As a result, a signal transmitted through the transmission line 25 generates a resonance point. The resonant frequency is a frequency based on the width a.

In addition, as illustrated in FIG. 1(A), a distance between the line width step portion 32 and the GND pattern 42 is determined as a distance c. A distance between the other portions and the GND pattern 42 is determined as a distance d. In the microwave circuit 1, the distance c and the distance d are different from each other. As a result, the signal transmitted through the transmission line 25 generates a resonance point. The resonant frequency is a frequency is a frequency based on the distance c.

In addition, as illustrated in FIG. 1(A), a distance between the line width step portion 32 and the via 13, 14, 18, or 19 is determined as a distance e. A distance between one of the other portions and one of the vias 51 to 57 or one of the vias 58 to 64 is determined as a distance f. As a result, the signal transmitted through the transmission line 25 generates a resonance point. The resonant frequency is a frequency based on the distance e.

In the microwave circuit 1, the widths a and b and the distances c to f are adjusted as necessary to adjust impedance. In FIG. 1(A), the three resonance points are generated and there are the three resonant frequencies. Therefore, a broadband matching circuit can be realized.

In addition, for example, assume that a broadband matching circuit whose carrier wave frequency band is set at 60 GHz and has a frequency bandwidth of 3 GHz or wider and whose fractional bandwidth is 5% or higher is realized. In this case, a plurality of open stub resonators whose resonant frequencies are different from one another due to different line widths can be arranged on a transmission line. In this case, distances between the open stub resonators need to be λ/4 or larger at frequencies higher than those of microwaves. Therefore, length L of the transmission line reaches about one wavelength (λ), and it is difficult to decrease the length of the transmission line L.

On the other hand, in the microwave circuit 1, capacitance changes at a point at which the line width of the transmission line 25 changes, that is, at a boundary between the first transmission line 25a or the second transmission line 25b and the line width step portion 32. Therefore, the wavelength of a signal transmitted through the transmission line 25 decreases. As a result, a phase shift caused in a transmission line between the vias 15 and 17 becomes large compared to when the wavelength does not decrease, and physical length decreases relative to electrical length. Therefore, the distance between the vias 15 and 17, which corresponds to the length of the transmission line 25, can be reduced to less than a quarter of the wavelength (λ). Accordingly, the microwave circuit 1 can be reduced in size.

Thus, in the microwave circuit 1, ground vias are arranged within a certain distance from lines (for example, the extended lines m1 and n1) along points (the sides of the line width step portion 32 extending in the Y direction) at which the line width of the transmission line 25 changes. That is, positions at which the ground vias are provided are adjusted in accordance with the shape of the transmission line 25. The amount of radiation of radio waves from the points at which the line width of the transmission line 25 changes is larger than that at another position. By providing the ground vias on or around the lines, leakage current from the line width step portion 32 and the ground vias can be electromagnetically coupled with each other. As a result, the deterioration of the transmission characteristics can be suppressed. In addition, since the plurality of ground vias surround the transmission line 25, the deterioration of the transmission characteristics can be suppressed.

In addition, since the distance (distance c) between the line width step portion 32 and the GND pattern 42 is smaller than the distance (distance d) between the first transmission line 25a or the second transmission line 25b and the GND pattern 42, the transmission line 25 and the GND pattern 42 can be electromagnetically coupled with each other easily. Therefore, leakage current from the line width step portion 32 and the GND pattern 42 can be electromagnetically coupled with each other, thereby suppressing the deterioration of the transmission characteristics.

In addition, by adjusting the widths a and b and the distances c to f, impedance can be matched at a desired value. Therefore, a plurality of resonant frequencies of a signal transmitted through the transmission line 25 can be generated in a desired manner to design a desired band. Accordingly, a broadband microwave circuit 1 can be realized.

Thus, according to the microwave circuit 1, a band can be widened, the deterioration of the transmission characteristics can be suppressed, and the microwave circuit 1 can be reduced in size.

### Second Embodiment

In a second embodiment, for example, a case will be described in which the line width of a line width step portion is the same as that in the first embodiment but the line width step portion protrudes on one side in a width direction (Y direction) of a transmission line.

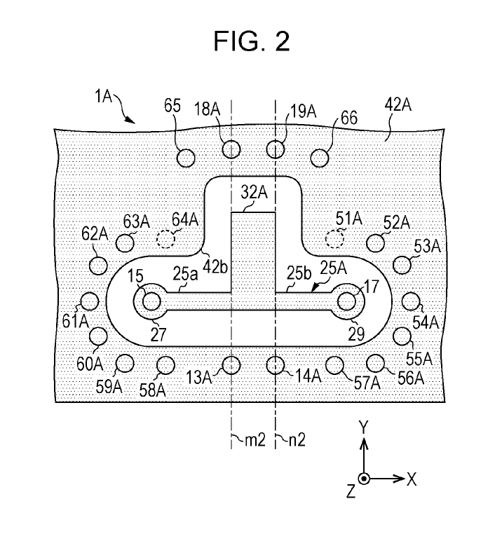

FIG. 2 is a plan of an example of the structure of a microwave circuit 1A according to the second embodiment. In the microwave circuit 1A illustrated in FIG. 2, the same components as those of the microwave circuit 1 according to the first embodiment are given the same reference numerals, and description thereof is omitted or simplified.

In the microwave circuit 1A, a line width step portion 32A is formed to protrude on one side of a transmission line 25A, that is, in the width direction (Y direction), in a central portion of the transmission line 25A in a longitudinal direction (X direction). That is, in FIG. 2, the line width step portion 32A protrudes upward in the Y direction.

Thus, a side along the X direction of the line width step portion 32A substantially aligns with a side of the first transmission line 25a and a side of the second transmission line 25b. In addition, another side along the X direction of the line width step portion 32A is deviating from (a certain distance away from) a substantially straight line including another side of the first transmission line 25a and another side of the second transmission line 25b.

In addition, a peripheral portion 42b (inner peripheral portion) of the GND pattern 42A recedes in accordance with the shape of the line width step portion 32A.

In addition, four vias 18A, 19A, 13A, and 14A are arranged on or around lines m2 and n2 extending from sides along the Y direction of the line width step portion 32A. As in the first embodiment, the four vias 18A, 19A, 13A, and 14A are arranged near the peripheral portion 42b of the GND pattern 42A. In addition, a distance between the via 18A and the via 19A is set to one eighth of the wavelength of a microwave (carrier wave) on the board.

It is to be noted that since the transmission line 25A does not protrude downward in the Y direction, the two vias 13A and 14A do not contribute to improving electromagnetic coupling, and therefore may be omitted.

In addition, vias 65 and 66 connected to the first GND layer 8 and the second GND layer 9 are provided at positions corresponding to corner portions of the receding peripheral portion 42b. In addition, vias may or may not be provided between the via 19A and the via 66 and between the via 18A and the via 65.

According to the microwave circuit 1A, the same advantageous effect as that according to the first embodiment can be produced, and, by forming the line width step portion 32A in free (vacant) space in the second wiring layer 5 of the multilayer board 3, the vacant space can be effectively utilized.

It is to be noted that although the line width step portion 32A is formed upward of the transmission line 25A in FIG. 2 in the above embodiment, the line width step portion 32A may be formed to protrude downward, instead.

### Third Embodiment

In the first and second embodiments, the shapes of the line width step portions are rectangular. In a third embodiment, a case in which the shape of a line width step portion is different from those in the first and second embodiments will be described.

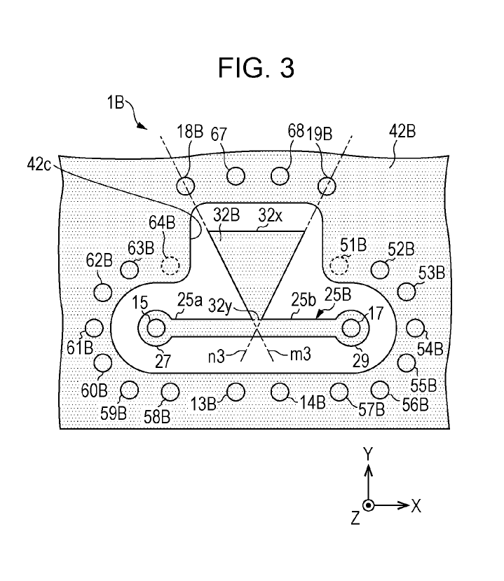

FIG. 3 is a plan of an example of the structure of a microwave circuit 1B according to the third embodiment. As in the second embodiment, a line width step portion 32B is formed to protrude on one side of a transmission line 25B. In the microwave circuit 1B illustrated in FIG. 3, the same components as those of the microwave circuits 1 and 1B according to the first and second embodiments are given the same reference numerals, and description thereof is omitted or simplified.

A line width step portion 32B is formed, for example, to have an inverted triangular shape, which tapers on a side of the transmission line 25B and widens on an opposite side. As in the second embodiment, a peripheral portion 42c (inner peripheral portion) of a GND pattern 42B is formed to recede. In FIG. 3, a side 32x of the line width step portion 32B that faces the peripheral portion 42c of the GND pattern 42B is longer than a portion 32y that is parallel to the GND pattern 42B and that is connected to the first transmission line 25a and the second transmission line 25b.

In addition, vias 18B and 19B connected to the first GND layer 8 and the second GND layer 9 are arranged on or around lines m3 and n3, respectively, extending from two sides of the line width step portion 32B. In this case, the extended lines m3 and n3 intersect at a vertex of the inverted triangle. It is to be noted that vias 67 and 68 provided between the vias 18B and 19B may be omitted.

In addition, as in the second embodiment, vias 13B and 14B located on an opposite side of the line width step portion 32B from the transmission line 25B do not contribute to improving electromagnetic coupling, and may be omitted.

According to the microwave circuit 1B, the same advantageous effect as that according to the first and second embodiments may be produced. In addition, in the microwave circuit 1B, the side 32x of the line width step portion 32B is longer than the sides of the line width step portions according to the first and second embodiments that face the inner peripheral portions of the GND patterns. Therefore, electromagnetic coupling between the line width step portion 32B and the GND pattern 43B can improve.

In addition, the capacitance between the side 32x of the line width step portion 32B and the first GND layer 8 and the second GND layer 9 is larger than in the first and second embodiments. Thus, when the capacitance on the side of the side 32x, which is close to the GND pattern 42B increases, the side 32x acts as an open terminal, thereby widening a band because of characteristics of a stub. Bands can also be widened in the first and second embodiments for the same reason, but according to the microwave circuit 1B, a band wider than those in the first and second embodiments can be realized.

It is to be noted that although the line width step portion 32B is formed upward of the transmission line 25A in FIG. 3, the line width step portion 32B may be formed to have a triangular shape protruding downward.

The present disclosure is not limited to the configurations according to the above embodiments, and any configuration may be adopted insofar as the functions disclosed in the claims or the functions of the configurations according to the above embodiments can be achieved.

For example, in each of the above embodiments, the line width of the line width step portion is larger than those of the other portions. That is, the transmission line is formed such that the line width thereof changes from narrow to wide, and then to narrow in the longitudinal direction (X direction). Alternatively, the line width of the line width step portion may be smaller than those of the other portions.

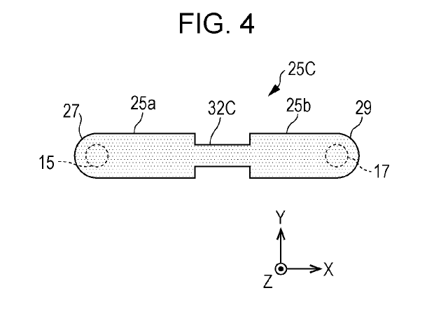

FIG. 4 is a plan of an example of the shape of a transmission line 25C according to a modification. As illustrated in FIG. 4, the transmission line 25C may be formed such that the line width thereof changes from wide to narrow, and then to wide in the longitudinal direction (X direction). Other portions illustrated in FIG. 4 (for example, the shape of the peripheral portion 42a of the GND pattern 42) are the same as those according to the first embodiment.

As in the modification illustrated in FIG. 4, by making the width of the line width step portion 32C smaller than those of the other portions, the same advantageous effect can be produced.

In addition, in each of the above embodiments, the shape of the inner peripheral portion of the GND pattern surrounding the transmission line is elliptical. Alternatively, a distance between the line width step portion and the peripheral portion of the GND pattern may change in accordance with the shape of the line width step portion. As a result, capacitance between the line width step portion and the peripheral portion of the GND pattern can be adjusted.

In addition, although the line width step portion according to the third embodiment has an inverted triangular shape, it is sufficient that the length of the line width step portion facing the peripheral portion be longer than the length of a portion connected to the first transmission line and the second transmission line, or the line width step portion may have another shape. For example, the line width step portion need not be a triangle, but may be another polygon (for example, a trapezoid or a pentagon). As a result, as in the case of an inverted triangle, larger capacitance can be generated.

In addition, although a transmission line having a different line width is arranged in a central portion of transmission lines in the longitudinal direction (X direction) in each of the above embodiments, the transmission line having a different line width may be, for example, arranged at an end (for example, a left end) or another end (for example, a right end) of the transmission lines in the X direction, instead. In this case, too, the same advantageous effect as that described above may be produced.

In addition, although the line widths of the first transmission line 25a and the second transmission line 25b are substantially the same in each of the above embodiments, the line widths of the first transmission line 25a and the second transmission line 25b may be different from each other. That is, three different line widths may be used. In this case, too, the same advantageous effect as that described above may be produced.

In addition, although the transmission line can be divided into three regions whose line widths are different from one another in each of the above embodiments, the transmission line may be divided into four or more regions, instead.

In addition, although a multilayer board is assumed in each of the above embodiments, a single-layer board may be used, instead.

### Overview of Embodiment of Present Disclosure

A first microwave circuit disclosed in the present disclosure includes a first transmission line, a second transmission line, a third transmission line that is connected to the first transmission line and the second transmission line and whose line width is different from line width of the first transmission line and line width of the second transmission line, and a first ground conductor that surrounds the first transmission line, the second transmission line, and the third transmission line, respectively, at certain distances.

In addition, a second microwave circuit disclosed in the present disclosure is the first microwave circuit. The line width of the third transmission line is larger than the line width of the first transmission line and the line width of the second transmission line.

In addition, a third microwave circuit disclosed in the present disclosure is the first or second microwave circuit. The first transmission line, the second transmission line, the third transmission line, and the first ground conductor are arranged on a first layer of a multilayer board. A second ground conductor is arranged on a second layer, which is located adjacent to the first layer of the multilayer board.

In addition, a fourth microwave circuit disclosed in the present disclosure is the third microwave circuit including a via that electrically connects the first ground conductor, which is arranged on the first layer of the multilayer board, and the second ground conductor, which is arranged on the second layer, to each other.

In addition, a fifth microwave circuit disclosed in the present disclosure is the fourth microwave circuit further including a via that electrically connects the first ground conductor, which is arranged on the first layer of the multilayer board, and the second ground conductor, which is arranged on the second layer, to each other.

In addition, a sixth microwave circuit disclosed in the present disclosure is any of the first to fifth microwave circuits. A side along a longitudinal direction of the third transmission line substantially aligns with a side of the first transmission line and a side of the second transmission line, and another side along the longitudinal direction of the third transmission line is, by a certain distance, away from a substantially straight line including another side of the first transmission line and another side of the second transmission line.

In addition, a seventh microwave circuit disclosed in the present disclosure is any of the first to sixth microwave circuits. The third transmission line is formed as a certain polygon, and length of a side of the third transmission line facing the first ground conductor is longer than length of a portion that is parallel to the side of the third transmission line facing the first ground conductor and that is connected to the first transmission line and the second transmission line.

### INDUSTRIAL APPLICABILITY

An embodiment of the present disclosure is effective in a microwave circuit or the like that can suppress deterioration of transmission characteristics and that can be reduced in size.

### REFERENCE SIGNS LIST

1, 1A, 1B, 1C microwave circuit
3 multilayer board
3a metal layer
3b dielectric layer
4 first wiring layer
5 second wiring layer
6 third wiring layer
8 first GND layer
9 second GND layer
13, 14, 18, 19, 51 to 64, 13A, 14A, 18A, 19A, 51A to 64A, 65, 66, 13B, 14B, 18B, 19B, 51B to 64B, 67, 68 via (ground via)
15, 17 via (signal via)
25, 25A, 25B, 25C transmission line
25a first transmission line
25b second transmission line
27, 29 pad
32, 32A, 32B, 32C line width step portion
42, 42A, 42B GND pattern
42a, 42b, 42c peripheral portion
m1, n1, m2, n2, m3, n3 extended line

1. A microwave circuit comprising:
a first transmission line for transferring a microwave;
a second transmission line for transferring the microwave;
a third transmission line for transferring the microwave, the third transmission line being connected to the first transmission line and the second transmission line, and line width of the third transmission line being different from line width of the first transmission line and line width of the second transmission line;
a first ground conductor that surrounds the first transmission line, the second transmission line, and the third transmission line, respectively, at certain distances; and
two vias that are arranged in the first ground conductor and respectively arranged on or around lines extending from sides along a width direction of the third transmission line, wherein a gap between the two vias is one eighth of a wavelength of the microwave that is transferred.

2. The microwave circuit according to claim 1,
wherein the line width of the third transmission line is larger than the line width of the first transmission line and the line width of the second transmission line.

3. The microwave circuit according to claim 1,
wherein the first transmission line, the second transmission line, the third transmission line, and the first ground conductor are arranged on a first layer of a multilayer board, and
wherein a second ground conductor is arranged on a second layer of the multilayer board and is connected to the first ground conductor.

4. The microwave circuit according to claim 3,
wherein the two vias electrically connect the first ground conductor, which is arranged on the first layer of the multilayer board, and the second ground conductor, which is arranged on the second layer, to each other.

5. The microwave circuit according to claim 4,
wherein each of the two vias is arranged in the first ground conductor within a certain distance from a line extending from a side along a width direction of the third transmission line.

6. The microwave circuit according to claim 1,
wherein a side along a longitudinal direction of the third transmission line substantially aligns with a side of the first transmission line and a side of the second transmission line, and another side along the longitudinal direction of the third transmission line is, by a certain distance, away from a substantially straight line including another side of the first transmission line and another side of the second transmission line.

7. The microwave circuit according to claim 1,
wherein the third transmission line is formed as a certain polygon, and length of a side of the third transmission line facing the first ground conductor is longer than length of a portion that is parallel to the side of the third transmission line facing the first ground conductor and that is connected to the first transmission line and the second transmission line.
